(19) United States
(12) Patent Application Publication
(10) Pub. No.: US 2005/0096921 A1
(43) Pub. Date: May 5, 2005

(54) METHOD AND SYSTEM TO MANAGE DOCUMENTATION

(76) Inventors: Monica P. Felder, Raleigh, NC (US); SEAN P LOGUE, MORRISVILLE, NC (US)

Correspondence Address: MOORE & VAN ALLEN, PLLC, P.O. Box 13706, Research Triangle Park, NC, 27709, US

(21) Appl. No.: 10/605,904

(22) Filed: Nov. 5, 2003

(51) Int. Cl. G06F 17/60

(52) U.S. Cl. 705/1

(57) ABSTRACT

A method to manage documentation may include assigning a predetermined number of line items to each writer. The method may also include reviewing and investigating each assigned line item and performing any line item changes to each assigned line item across all affected books.

### BACKGROUND OF INVENTION

The present invention relates to documentation for software or the like and more particularly to a method and system to manage documentation in software development or the like.

In software development, books or documentation related to installation, use, application and diagnosis of problems associated with the software are also typically developed in conjunction with the code. Examples of such books or documentation may be an installation guide, a user's guide, a programming guide, a diagnosis guide, a reference guide and the like. In a typical code development project, a base release product is developed. Subsequent changes, that may be referred to as “line items” may be added to the base code. The next release of the software product may therefore be composed of the base code along with the collection of line item changes made during the production cycle.

A typical way to manage the software documentation associated with the code development is to start with the base release of the books or documentation and update each book with all of the line items that affect it. This may be done by assigning a technical writer as owner or the one who has responsibility for each book. The book owner will investigate each line item in the release by using the line item design documents and by interviewing developers. Any changes that are required for that book are then made by the owner. One problem associated with this approach is that a technical writer must read through and learn every line item to determine whether the line item affects their book or books. This can be very laborious and inefficient. Additionally, there can be numerous line items. As many as 75-100 or more line items per release may not be unusual. This extensive volume of line items may be too difficult for an individual writer to read and understand to any depth or detail. Further, an individual writer may not be an expert on any particular line item. Therefore, a developer or owner of a line item may need to meet with every writer who identifies the line item as one that may affect his assigned book or books to discuss the line item in detail. Accordingly, important details or items may be overlooked or lost and technical errors may exist in the documentation or books because of incomplete understanding, lack of time or both or for other reasons.

### SUMMARY OF INVENTION

In accordance with an embodiment of the present invention, a method to manage documentation may include assigning a predetermined number of line items to each writer. The method may also include reviewing and investigating each assigned line item and performing any changes related to each assigned line item across all affected books.

In accordance with another embodiment of the present invention, a method to manage documentation in software development may include assigning a predetermined number of line items to each writer. The method may also include reviewing and investigating each assigned line item and performing any changes related to each assigned line item across all affected books. Any changes may be reviewed for each line item across all books and each line item may be closed in response to review and approval of all changes related to the line item across all books.

In accordance with another embodiment of the present invention, a system to manage documentation may include a processor to track each line item, wherein a predetermined number of line items may be assigned to each writer. A memory may be associated with the processor to store at least one book. The at least one book may be accessible to perform any changes related to each line item affecting the at least one book.

In accordance with another embodiment of the present invention, a system to manage documentation may include means for assigning a predetermined number of line items to each writer. A system memory may store the line item assignments. At least one book may be storable on the system memory. The system may also include means for accessing and performing any changes related to each line item across all affected books.

In accordance with another embodiment of the present invention, a computer-readable medium having computer-executable instructions for performing a method that may include tracking each line item and facilitating any changes related to each line item across each affected book.

### BRIEF DESCRIPTION OF DRAWINGS

FIGS. 1A and 1B (collectively FIG. 1) are a flow chart of a method to manage documentation in accordance with an embodiment of the present invention.

FIG. 2 is a block diagram of a system to manage documentation in accordance with an embodiment of the present invention.

FIG. 3 is a block diagram of a system to manage documentation in accordance with another embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

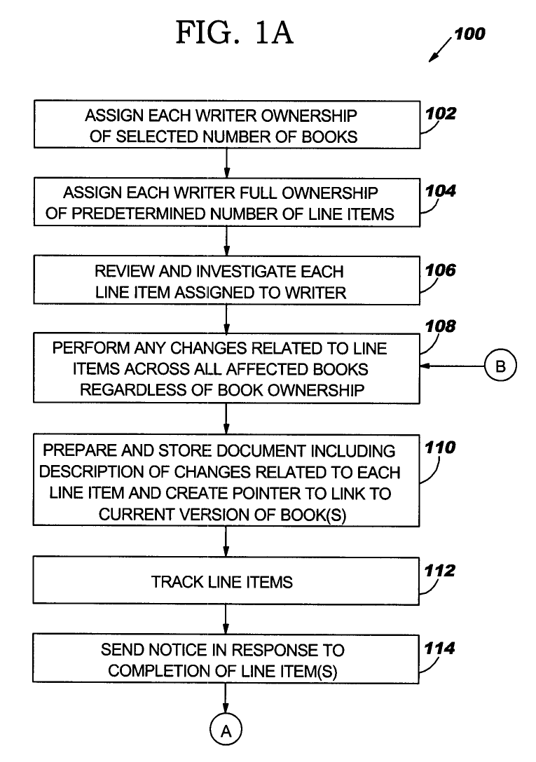

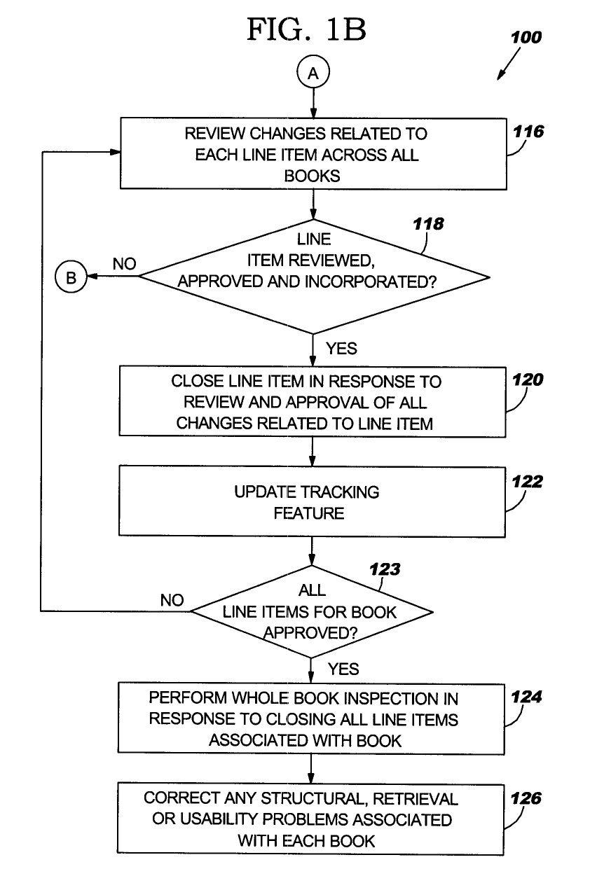

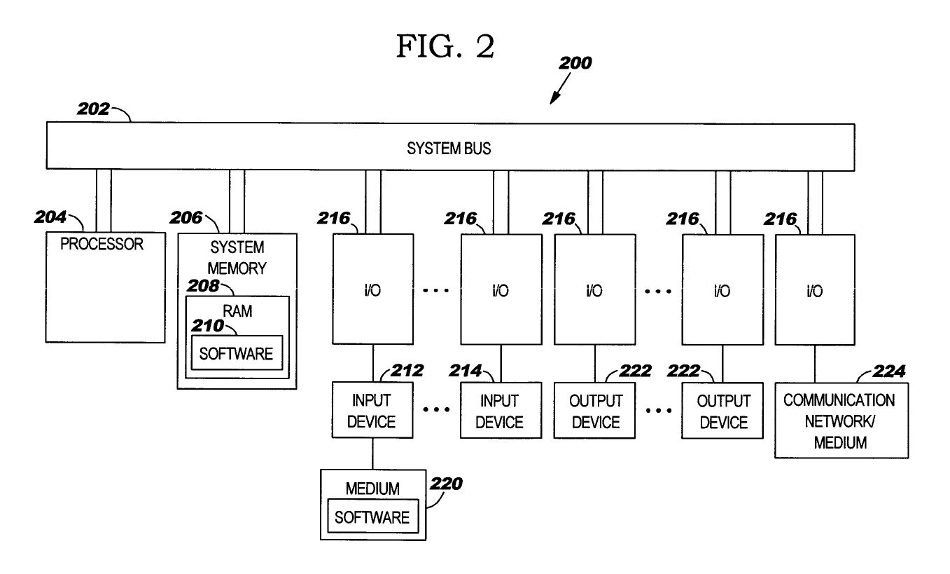

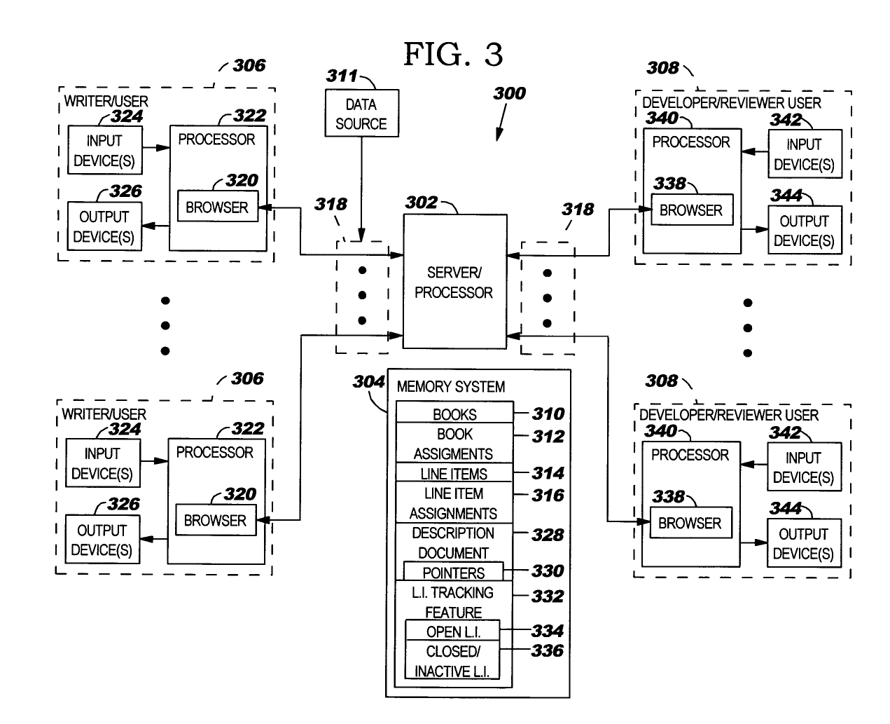

FIGS. 1A and 1B (collectively FIG. 1) are a flow chart of a method 100 to manage documentation in accordance with an embodiment of the present invention. In block 102, each writer or technical writer may be assigned ownership or responsibility for a selected book or selected number of books. In block 104, each writer may be assigned ownership or responsibility for a predetermined number of line items that may be associated with the release of a software product or the like. As discussed in more detail hereinbelow, the book assignments and line item assignments may be stored in a memory system associated with a data processing system or similar system, such as system 200 of FIG. 2, system 300 of FIG. 3 or the like. In block 106, each line item may be reviewed and investigated by the writer to whom the line item is assigned. The line item may be reviewed by the writer by using the line item design documents and by interviewing the developer or developers of the line item. In block 108, any changes related to the line item may be performed by the writer across all affected books regardless of the ownership of the books. In block 110, a document may be prepared including a description of changes related to each line item and a pointer associated with the description of the change or changes may also be created to link or point to a current version of the book. The current version of the book may be accessed online via an Internet or Web type browser or the like. The description document may be stored in a memory system of a data processing system or similar system, such as system 200 or 300 of FIGS. 2 and 3, respectively.

In block 112, each line item may be tracked with respect to an owner of the line item, planned and actual start dates, planned and actual end dates or completion dates for any changes related to the line item, any driver associated with the line item, status of the line item, issues associated with the line item and the like. Tracking the line items and storing the data associated therewith may be performed by a processor, server or the like and an associate memory of a system, such as system 200 or 300 of FIGS. 2 and 3, respectively.

In block 114, a notice or message may be sent to a developer or other interested or designated person or persons in response to completion of a line item or line items associated with an affected book or books. The notice may be sent for completion of each individual line item or after all line items for a particular book have been completed. The notice may advise the developer or other person that a particular line item or items are ready for review and approval or that all line items associated with a particular book have been completed and are ready for review and approval. The notice may be sent via e-mail or similar means of communication. In block 116, the changes related to a line item or each line item across all books may be reviewed in response to the notice. In block 118, if the changes related to the line item have been reviewed but not approved, the method 100 may return to block 108 where the changes related to the line item may be revised and the method 100 may continue as previously described. If the changes related to the line item have been reviewed, approved and incorporated in the software and documentation in block 118, the method 100 may advance to block 120. In block 120, the line item may be closed in response to review and approval of all changes related to the line item across all books. The tracking feature of the present invention may be updated in block 122 to indicate the actual end or closure of the line item and the line item may be moved to a list of closed or inactive line items. Any line items determined not to need any changes with respect to a release of a software product or the like may be moved to a closed or inactive list of line items.

In block 123, a determination may be made if all line items for a book or, alternatively, for each book have been reviewed, approved and incorporated. If not all line items for a book or for each book have been approved, the method 100 may return to block 116 for any remaining changes related to all line items for a book or for each book to be reviewed. If all line items for a book or, alternatively, each book have been reviewed, approved and incorporated in block 123, the method 100 may advance to block 124. In block 124, a whole book inspection may be performed in response to closing all line items associated with an affected book. Each book may be reviewed by a small number of developers or testers who are each knowledgeable with the particular book. In block 126, any structural, retrieval or usability problems associated with a book may be corrected as part of the whole book inspection.

Accordingly, with the present invention, writers only need to understand and investigate those line items assigned to them as opposed to having to review all line items and determine which ones may affect the books assigned to them. Line items may be assigned to writers according to a writer's expertise and experience with particular types of line items, operations or technology. Line item development owners only need to meet with a single writer assigned to the line item and not with every writer who may feel his assigned book may be impacted by the line item. Review time for each line item may be increased for a greater depth of understanding and less chance that something may be missed or overlooked because a writer does not have to be concerned with reviewing all line items and determining which ones affect the writer's assigned books. Changes may be made by a single writer across the entire library, thus increasing writer skills and knowledge of the library. Errors may be caught early in the cycle, reducing costs and improving efficiencies. The documentation for individual line items may be ready earlier, generally about the same time as the code. This allows the test group to review the documentation along with the code permitting discovery and correction of any additional errors and improving quality.

FIG. 2 is a block diagram of an example of a typical system 200 adapted to manage documentation in accordance with an embodiment of the present invention. Elements of the method 100 of FIG. 1 may be implemented or embodied in the system 200. The system 200 may include a system bus 202 for communication between different components of the system 200. The system 200 may also include a processor 204 that may be coupled to the system bus 202. A system memory 206 may also be coupled to the system bus 202. The system memory 206 may include a random access memory (RAM) 208 or the like to store software 210. Elements of the method 100 may be embodied as software, computer-usable or computer-executable instructions stored in the system memory 206. One or more input devices 212 and 214 may also be coupled to the system bus 202 via an input/output interface 216 or the like. Input devices 212 and 214 may also be combination input/output devices. The input devices 212 may be any of an optical, magnetic, infrared, voice recognition or radio frequency input device, combination input/output device or the like. The input devices 212 may receive, read or download software or the like, such as software embodying the method 100, from a medium 220. Examples of the medium 220 may be or form part of a communication channel, memory or similar devices. The medium 220 may be any medium that may contain, store, communicate or transport the data embodied thereon for use by or in connection with the input device 212 or system 200. The medium 220 may, for example, be an electronic, magnetic, optical, electromagnetic, infrared or semiconductor system or the like. The medium 220 may also be simply a stream of information being retrieved when the data is “downloaded” through a network such as the Internet or a private network. The input devices 214 may be a keyboard, pointing device or the like.

One or more output devices 422 may also be coupled to the system bus 202 via an I/O interface 216 or the like. The output devices 222 may include a display or monitor, printer, audio system or the like. The system 200 may also be coupled to a communication network or medium 224. The communication medium or network 224 may be coupled to the system bus 202 via an I/O interface 216 or the like. The communication network or medium 224 may be any communication system including by way of example, dedicated communication lines, telephone networks, wireless data transmission systems, two-way cable systems, customized computer networks, interactive kiosk networks, the Internet and the like.

FIG. 3 is a block diagram of a system 300 to manage documentation in accordance with another embodiment of the present invention. Elements or features of the method 100 may be embodied or carried out using the system 300. The system 300 may include a server 302, processor or like. A memory system 304 or the like may be associated with the server 302. The memory system 304 may include multiple data sources or data storage devices; however, only one is shown in FIG. 3 for purposes of clarity and explanation of one embodiment of the present invention. The system 300 may be accessed by one or more technical writers 306 or the like and by one or more developers 308, reviewers or the like. The writers 306 may be technical writers that may be assigned ownership or responsibility for developing or writing a selected number of books 310 or documentation related to a particular software product as previously described with respect to the method 100 in FIG. 1. The books 310 may be stored electronically on the memory system 304 or another data source, such as data source 311, that may be accessed by each writer 306 to make changes to the books 310. Book assignments 312 that may be made to each writer 306 may be stored in the memory system 304 or other data source. As previously described, each writer 306 may also be assigned ownership or responsibility for a predetermined number of a plurality of line items 314 associated with a particular software product or release of a software product. The plurality of line items 314 may also be stored on the memory system 304 or other data source that may be accessed by each writer 306 via the system 300. Assignments 316 of each of the line items 314 to each of the writers 306 may also be stored on the memory system 304 or other data source.

As previously described, each writer 306 may review and investigate each line item 316 assigned to the writer 306. The writer 306 may then perform any changes related to a line item 314 across all affected books 310 regardless of ownership of the affected books 310. Each writer 306 may access the system 300 to make changes to the books 310 over a network 318 using an Internet or web browser 320 or the like operating on a processor 322. The network 318 may be private network, the Internet or the like. An input device or devices 324 and an output device or devices 326 may be associated with each writer 306 and coupled to each processor 322. The input devices 324 and output devices 326 may facilitate presenting the books 310 and line items 314 to the writer 306 so that the writer 306 may make any changes related to each assigned line item 314 across all affected books 310. The input device or devices 324 may be similar to the input devices 212 and 214 described with respect to FIG. 2 and may include a keyboard, pointing device and the like. The output device or devices 326 may be similar to the output devices 222 described with respect to FIG. 2 and may include a monitor, printer or the like.

As previously described, the writer 306 after performing any changes to line items 314 may prepare and store a description document 328 or documents including a description of changes related to each line item 314. The writer 306 may also create a pointer 330 associated with each line item change or related changes to provide a link or access to the a current version of the book 310 or section of the book 310 affected by the line item 314.

A line item tracking feature 332, similar to that previously described with respect to block 112 in FIG. 1 may also be provided by the system 300 and stored on the memory system 304 or other data source, such as data source 311. The line item tracking feature 332 may track or maintain a list of all open line items 334 and a list of all closed or inactive line items 336. The line item tracking feature 332 may also include a description of each line item 314, the line item owner, a planned and actual start date or time for each line item 314 and a planned and actual end date or time for each line item 314. The line item tracking feature 332 may also include information related to any driver associated with the line item 314, the line item status, any issues associated with the line item 314 and similar data or information for tracking each line item 314.

A notice may be sent in response to completion of each line item 314 or all line items 314 associated with an affected book 310 or section of a book 310. The notice may be generated by actions of the writer 306 to be sent to the developer 308 who developed that portion of the code related to the line item 314 or to the developer or reviewer most familiar with that line item 314 or related portion of the code. The notice may be sent via e-mail or similar electronic means, such as over the network 318. The developer 308 may then access the system 300 to review the line item changes and books 310. The developer 308 may access the system 300 via the network 318 by using an Internet or web type browser 338 or the like operating on a processor 340 or the developer 308 may access the line item changes and books 310 by way of other means. The browser 338 and processor 340 may be similar to the browser 320 and processor 322 used by the writers 306. One or more input devices 342 and one or more output devices 344 may be coupled to the processor 340 to facilitate the developer 308 accessing the system 300. The developer 308 may then review and approve or reject any changes related to each line item 314 across all books 310 and provide any comments or revisions to the writer 306. The input device or devices 342 may be similar to input devices 212 and 214 described with respect to FIG. 2 and may include a keyboard, pointing device and the like. The output device or devices 344 may be similar to the output devices 222 described with respect to FIG. 2 and may include a monitor, printer, audio system or the like. Any rejected line items 314 may be returned to the writer 306 for further revisions. Any approved line items 314 may be added to the closed or inactive line item list 336 as previously discussed. After review and approval of all line items associated with a book 310, a whole book 310 inspection may be performed. During the whole book inspection, any structural, retrieval or usability issues associated with the book 310 may be resolved. The whole book inspection may be performed by accessing the books 310 online using a browser, such as browser 338, or by other means.

Elements of the present invention, such as method 100 may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in the medium for use by or in connection with a system, such as system 200 of FIG. 2 or system 300 of FIG. 3. Examples of such a medium may be illustrated in FIG. 2 as input devices 214 or medium 224 and in FIG. 3 as input devices 322 and 324 and network 318. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as network 318, the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. For example, the structure and method of the present invention may be used in publishing or any environment where it may be desirable to review information, data or documentation. This application is intended to cover any adaptations or variations of the present invention. The following claims are in no way intended to limit the scope of the invention to the specific embodiments described herein.

1. A method to manage documentation, comprising:
assigning a predetermined number of line items to each writer;
reviewing and investigating each assigned line item; and
performing any changes related to each assigned line item across all affected books.

2. The method of claim 1, further comprising electronically accessing each affected book to perform any changes.

3. The method of claim 1, wherein each change is performed across all affected books regardless of book ownership.

4. The method of claim 1, further comprising:
preparing a document including a description of each change for each book; and
storing the document in a selected location in a memory.

5. The method of claim 4, further comprising creating a pointer associated with each description of each change to link to a current version of the associated book.

6. The method of claim 1, further comprising tracking line items and changes related to the line items.

7. The method of claim 1, further comprising sending a notice in response to completion of any changes related to each line item.

8. The method of claim 1, further comprising sending a notice in response to completion of any changes related to all assigned line items.

9. The method of claim 1, further comprising reviewing any changes related to each line item across all books.

10. The method of claim 1, further comprising closing each line item in response to review and approval of all changes related to the line item.

11. The method of claim 10, further comprising performing a whole book inspection in response to closing all line items associated with the book.

12. The method of claim 11, further comprising correcting any structural, retrieval or usability problems associated with each book.

13. The method of claim 1, further comprising assigning each writer responsibility for a selected number of books.

14. A method to manage documentation in software development, comprising:
assigning a predetermined number of line items to each writer;
reviewing and investigating each assigned line item;
performing any changes related to each assigned line item across all affected books;
reviewing any changes for each line item across all books; and
closing each line item in response to review and approval of all changes related to the line item across all books.

15. The method of claim 14, wherein each change is performed across all affected books regardless of book ownership.

16. The method of claim 14, further comprising:
preparing a document including a description of each change for each book; and
storing the document in a selected memory location.

17. The method of claim 16, further comprising creating a pointer associated with each description of each change to link to a current version of the affected book.

18. The method of claim 14, further comprising sending a notice in response to completion of any changes related to each line item.

19. The method of claim 14, further comprising reviewing any changes related to each line item across all books.

20. The method of claim 14, further comprising performing a whole book inspection on each book in response to closing all line items associated with the book.

21. A system to manage documentation, comprising:
a processor to track each line item, wherein a predetermined number of line item are assigned to each writer; and
a system memory associated with the processor to store at least one book, the at least one book being accessible to perform any changes related to each line item effecting the at least one book.

22. The system of claim 21, further comprising at least one input device to make changes related to any line items requiring such changes.

23. The system of claim 21, further comprising a document formable to include a description of each change for each book.

24. The system of claim 23, wherein the document is stored in a selected memory location in the system memory.

25. The system of claim 23, further comprising a pointer formable for association with the description of each change to link to a current version of the affected book.

26. A system to manage documentation, comprising:
means for assigning a predetermined number of line items to each writer;
a system memory to store line item assignments;
at least one book storable on the system memory; and
means for accessing and performing any changes related to each line item across all affected books.

27. The system of claim 26, further comprising means for preparing a document including a description of each change for each book.

28. The system of claim 27, wherein the document is storable in a selected memory location in the system memory.

29. The system of claim 27, further comprising means for creating a pointer associated with each description of each change to link to a current version of the affected book.

30. The system of claim 26, further comprising means for sending a notice in response to completion of any changes.

31. The system of claim 26, further comprising means for closing each line item in response to review and approval of all changes related to the line item.

32. A computer-readable medium having computer-executable instructions for performing a method, comprising:
tracking each line item; and
facilitating any changes related to each line item across each affected book.

33. The computer-readable medium having computer-executable instructions for performing a method of claim 32, further comprising sending a notice in response to completion of any changes related to each line item.

34. The computer-readable medium having computer-executable instructions for performing a method of claim 32, further comprising providing means for preparing a description of each change.

35. The computer-readable medium having computer-executable instructions for performing a method of claim 34, further comprising providing means for creating a pointer associated with each description of each change to link to a current version of the affected book.

36. The computer-readable medium having computer-executable instructions for performing a method of claim 32, further comprising closing each line item in response to review and approval of all change related to the line item.
